(19) United States
(12) Patent Application Publication
(10) Pub. No.: US 2026/0040256 A1
(43) Pub. Date: Feb. 5, 2026

(54) Methods and Systems for Compact Core Registration and Session Management with a Secure Connection to a Central Core Network System

(71) Applicant: T-Mobile Innovations LLC, Overland Park, KS (US)

(72) Inventor: Lyle W. PACZKOWSKI, Mission Hills, KS (US)

(21) Appl. No.: 18/791,002

(22) Filed: Jul. 31, 2024

(51) Int. Cl. H04W 60/04; H04M 15/00; H04W 12/06; H04W 64/00; H04W 76/10

(52) U.S. Cl. CPC H04W 60/04; H04M 15/66; H04W 12/068; H04W 64/003; H04W 76/10

(57) ABSTRACT

A method implemented in a communication network between a compact core system and a central core network system for registration and session management comprises transmitting, by a compact access and mobility management function (AMF) at the compact core system, a registration request to the central core network system, in which the registration request comprises data associated with the compact core system, and completing, by a central AMF at the central core network system, a registration of the compact core system by adding the data associated with the compact core system at a registration data store in the central core network system, and establishing, using a user plane function (UPF) at the compact core system, a connection between the compact AMF and a central AMF at the central core network system over a network slice.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A core network (sometimes referred to herein as the “core network system”, owned and operated by a telecommunications service provider (TSP)), is the central part of a telecommunications network that provides various services to users, such as voice, data, and messaging. The core network includes various components and functions for managing and routing calls, data sessions, and internet connectivity, and the core network ensures efficient and reliable communication across the network. In this way, the core network provides centralized management, scalability, high performance, and seamless user experiences across different access networks and services.

When a User Equipment (UE) roams from a home network into a different telecommunication service provider's network, the core network manages this transition through a series of coordinated steps involving both networks. The visited network communicates with the home network to authenticate the roaming user and establish service continuity. This process may involve updating the location information in the Home Location Register (HLR) or Home Subscriber Server (HSS) of the home network and allocating appropriate resources in the visited network.

### SUMMARY

In an embodiment, a method implemented in a communication network between a compact core system and a central core network system for registration and session management is disclosed. The method includes transmitting, by a compact access and mobility management function (AMF) at the compact core system, a registration request to the central core network system, in which the registration request comprises data associated with the compact core system, and the data comprises an identifier of the compact core system, a location of the compact core system, and one or more capabilities of the compact core system, and completing, by the compact AMF, a registration of the compact core system by adding or confirming the data associated with the compact core system at a registration data store in the compact core system and the central core network system. The method further comprises establishing, using a first user plane function (UPF) at the compact core system, a connection between the compact AMF and a central AMF at the central core network system over a network slice, and receiving, by the compact AMF, a session establishment request from a user equipment (UE) to establish a session between the UE and an external system. The method further comprises transmitting, by the compact AMF, a policy request for one or more policies associated with the UE to the central AMF over the network slice using the first UPF, in which the central AMF obtains the one or more policies from a policy control function (PCF) of the central core network system, receiving, by the compact AMF, the one or more policies from the central AMF over the network slice using the first UPF, forwarding, by the compact AMF, the session establishment request and the one or more policies to compact session management function (SMF) at the compact core system, and configuring, by the compact SMF, a second UPF at the compact core system with forwarding rules to route traffic between the UE and the external system based on the one or more policies.

In another embodiment, a method implemented in a communication network between a compact core system and a central core network system for registration and session management is disclosed. The method comprises transmitting, by a compact access and mobility management function (AMF) at the compact core system, a registration request to the central core network system, in which the registration request comprises data associated with the compact core system, and the data comprises an identifier of the compact core system, a location of the compact core system, and one or more capabilities of the compact core system, and completing, by a central AMF at the central core network system, a registration of the compact core system by adding the data associated with the compact core system at a registration data store in the central core network system. The method further comprises establishing, using a user plane function (UPF) at the compact core system, a connection between the compact AMF and a central AMF at the central core network system over a network slice, transmitting, by the compact AMF to the central AMF over the network slice using the UPF, an update to a registration data store at the central core network system, in which the update comprises the data associated with the compact core system, and establishing, by the compact AMF and a compact session management function (SMF) at the compact core system, a session with a user equipment (UE). The method further comprises obtaining, by the compact AMF, data associated with the UE, and transmitting, by the compact AMF to the central AMF over the network slice using the UPF, the data associated with the UE based on a rule governing the transmission of the data to the central core network.

In yet another embodiment, a method implemented in a communication network between a compact core system and a central core network system for registration and session management. The method comprises determining, by the compact AMF, that the UE has moved out of a coverage area of the compact core system after the session is established with the UE under management of the compact core system, transmitting, by the compact AMF over the network slice using the first UPF, a handover request to a central AMF at the central core network system, transmitting, by the central AMF over the network slice using a second UPF, a response to the compact AMF to confirm initiation of a handover from the compact core system to the central core network system, transmitting, by the compact AMF, a first instruction to a serving cell site to execute the handover by terminating a first connection with the UE, and transmitting, by the central AMF, a second instruction to a target cell site to execute the handover by initiating a second connection with the UE to continue the session under management of the central core network system.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network according to various embodiments of the disclosure.

FIGS. 2A, 2B, and 2C are block diagrams illustrating methods for compact core system registration using a secure connection with a central core network system in the communication system of FIG. 1 according to various embodiments of the disclosure.

FIG. 3 is a block diagram illustrating a method for compact core system session management using a secure connection with a central core network system in the communication network of FIG. 1 according to various embodiments of the disclosure.

FIG. 4 is a block diagram illustrating a method for compact core system registration and session management using a secure connection with a central core network system in the communication network of FIG. 1 according to various embodiments of the disclosure.

FIGS. 5A and 5B are diagrams illustrating a handover process from a compact core system to a central core network system using a secure connection in the communication network of FIG. 1 according to various embodiments of the disclosure.

FIG. 6 is a flowchart of a first method for compact core system registration and session management using a secure connection with a central core network system in the communication network of FIG. 1 according to various embodiments of the disclosure.

FIG. 7 is a flowchart of a second method for compact core system registration and session management using a secure connection with a central core network system in the communication network of FIG. 1 according to various embodiments of the disclosure.

FIG. 8 is a flowchart of a third method for compact core system registration and session management using a secure connection with a central core network system in the communication network of FIG. 1 according to various embodiments of the disclosure.

FIGS. 9A and 9B are block diagrams illustrating a communication system similar to the communication system of FIG. 1 according to various embodiments of the disclosure.

FIG. 10 is a block diagram of a computer system implemented within the communication system of FIG. 1 according to various embodiments of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, UEs may roam into areas or regions that are not covered by the home network. However, these areas or regions may be covered by visited networks. A home network is the mobile network, including the core network components, where a user subscription and authentication details are originally registered and managed. A visited network is the external mobile network, including the external core network components, that temporarily provides service to a roaming user outside their home network coverage area.

For example, when the UE enters a region outside the home network coverage area, the UE may connect to the nearest cell tower of the visited network. The UE may evaluate a local Preferred Roaming List (PRL) to determine if the visited network is a preferred partner of the home network. The PRL is a database stored at all subscriber UEs that indicates a prioritize list of preferred networks for roaming based on agreements between the home network and other service providers. The visited network may send an authentication request to the home network, and the home network may update the UE location information to reflect that the UE moved into the area covered by the visited network. The visited network may assign a Temporary Mobile Subscriber Identity (TMSI) or other Mobile Station International Subscriber Directory Number (MSISDN) to the roaming UE, which essentially translates the home network number to a local number for billing and routing purposes. The UE then becomes authenticated on the visited network and can access services in the visited network while the home network manages billing and policy enforcement.

However, enabling UEs to roam between home networks and visited networks is a resource intensive and inefficient process, in that the process involves additional databases (e.g., the PRL) to be stored at the UEs and several translation computations to be performed to enable the UE to be compatible with the visited network while being billed by the home network. The inter-network communications between the core network system of the home network and the core network system of the visited network involved in the roaming process may also pose a heavy load on the network. Moreover, the roaming process between the home network and the visited network has not been enabled for compact core devices, which in some cases, may be enabled as the UEs purchased by subscribers.

A compact core system refers to a localized, lightweight implementation of core network functions designed to provide tailored services and efficient resource management within a specific, limited area. The compact core system may be a standalone device or computer system that is relatively lightweight and has a small footprint, and/or the compact core system may be provisioned at an existing device (e.g., modem, router, server in a data center, UE, reader device, personal computer, etc.). Compact core systems may be deployed in a variety of different environments. For example, the compact core systems may be deployed in various locations, such as within enterprise campuses, manufacturing facilities, rural or remote areas, private networks, or implemented as a part of different types of devices (e.g., UEs, reader devices, IoT devices, smart devices, etc.).

The compact core system includes hardware components, such as servers and switches, and various software modules for the essential core network functions. When the compact core system enables a Fourth Generation (4G) wireless network, the software modules may include, for example, Mobility Management Entity (MME), Serving Gateway (SGW), Packet Data Network Gateway (PGW), and Home Subscriber Server (HSS). When the compact core system enables a Fifth Generation (5G) wireless network, the software modules may include, for example, Access and Mobility Management Function (AMF), Session Management Function (SMF), one or more User Plane Functions (UPFs), and a Unified Data Management (UDM).

The compact core system may be used to manage user equipment (UE) registration, authentication, session management, data routing, security and policy enforcement, etc. The use of the compact core system for the core network functions (instead of the large-scaled centralized core network system) provides several technical benefits, such as, for example, reduced deployment costs, ease of management, and the ability to quickly scale network capacity. Moreover, positioning the compact core system within a private network or location reduces latency and improves overall data processing speeds for users.

However, as mentioned above, the central core network system (e.g., the macro-large scaled core network system owned and operated by a TSP) may not enabled with functionality to connect to and/or provide services to roaming compact core systems. Part of the reason is because not all compact core systems are tied to a single TSP and thus a single central core network system (e.g., many compact core systems are agnostic, and thus cannot “roam”). Another reason is because compact core systems may not be identified by MSISDNs that can be translated at the visited network for roaming purposes. Rather, the central core network systems are not enabled to perform similar translations to account for roaming or remote compact core systems. Compact core systems also may not include PRLs or other agreement-based configurations that may be used to determine whether to connect to a central core network system.

Moreover, compact core systems, whether stationary or mobile, may not be enabled to automatically connect to one or more central core network systems because interfaces may not yet be developed to automatically register compact core systems with the central core network systems. Compact core systems may also not have a secure, dedicated channel over which to communicate with the central core network systems, which may be significant since the data communicated between the two systems may be highly confidential (e.g., may contain personally identifiable information (PII) and billing information).

The present disclosure addresses the foregoing technical problems by providing a technical solution in the technical field of core networking, and particularly, one involving both a central core network system and one or more compact core systems. The embodiments disclosed herein automate the registration process between a compact core system and a central core network system by enabling the AMF at the compact core system to communicate with the AMF of the central core network system using a UPF, thereby eliminating the use of PRLs and other translation computations in the registration process. The embodiments disclosed herein also enable the creation of a network slice (e.g., dedicated or existing) to secure the communications between the AMF of the compact core system and the AMF of the central core network system. The use of the network slice for these communications enforces security mechanisms to protect the data being transmitted between the two systems.

In particular, the central core network system may include all of the core network function-related hardware and software resources, such as, for example, an AMF (sometimes referred to herein as “central AMF”), SMF (sometimes referred to herein as “central SMF”), one or more UPFs, a Unified Data Manager (UDM), an Authentication Server Function (AUSF), a Policy Control Function (PCF), a Network Repository Function (NRF), a Network Exposure Function (NEF), an application function (AF), etc. Meanwhile, the compact core system may include a subset of the core network function-related hardware and software resources (e.g., ¼ of the resources/lines of code from the central core network system). For example, the compact core system may include an AMF (sometimes referred to herein as a “compact AMF”), a SMF (sometimes referred to as a “compact SMF”), one or more UPFs, a network slice selection function (NSSF), a local UDM, a local PCF, etc. As should be appreciated, different compact core systems may include different combinations of core network functions, sometimes for different use cases and/or purposes as specified by the operator.

The compact core system may be configured and initiated (e.g., turned on) in various contexts. The compact core system may programmatically register with the central core network system via a cell site associated with the central core network system based on the context of the compact core system.

In one embodiment, the context of the compact core system may be one in which an operator of the compact core system is a subscriber of a TSP associated with the central core network system. The operator may also pay for a subscription plan specifically for the services, policies, and functions provided by the compact core system (e.g., the subscription plan may be a predefined package of services and usage limits for the compact core system offered to the user for a fee). In this embodiment, the operator may purchase a TSP-agnostic compact core system that is not associated with a specific central core network system. The compact core system may include a display and a user interface (e.g., via a touchscreen of the display or via a keyboard of the system). The operator may access an application or webpage associated with the subscribed-for TSP at the compact core system and enter security credentials (e.g., a username and password) into the system via the user interface.

The compact AMF of the compact core system may transmit a registration request with the security credentials and data associated with the compact core system to the nearest cell site associated with the subscribed-for TSP. The data associated with the compact core system may include identification data of the compact core system (e.g., value identifying the compact core system, location, etc.), network functions provisioned at the compact core system (e.g., compact AMF, compact SMF, compact UPFs, etc.), one or more hardware or software capabilities of the compact core system, local policies, authentication functions, data stores provisioned at the compact core system, etc. The TSP-specific cell site may forward the registration request to the central AMF at the central core network system.

The central AMF may receive the registration request and extract the security credentials (specifically the data identifying the user account) and identification data (of the compact core system) from the request. The central AMF may then forward an authentication request with the security credentials and the identification data to the AUSF, and the AUSF may verify the security credentials with a user account stored at the UDM of the central core network system. For example, the UDM may include data associated with the subscription plan purchased by the operator for the compact core system. When the AUSF identifies the user account and the subscription plan, the AUSF may transmit an authentication response indicating successful authentication to the central AMF. The central AMF may then store the data associated with the compact core system at a registration data store at the central core network system. At this point, the compact core system may already store the data associated with the compact core system at a local registration data store within the compact core system.

When the compact core system and the central core network system both maintain the data associated with the compact core system, the registration of the compact core system may be considered complete. Once registration is complete, the central AMF at the central core network system may transmit a registration response to the compact AMF at the compact core system. The registration response may indicate that the registration of the compact core system purchased or operated by the subscriber is complete.

The registration process may vary based on the different contexts of the compact core system. In another context, the compact core system may be pre-configured to be associated with a single TSP, and in this case, both the registration data store at the compact core system and the registration data store at the central core network system of the TSP may already maintain the data associated with the compact core system. In this case, when an operator initiates use of the compact core system, the compact AMF at the compact core system may be triggered to send the registration request (including data associated with the compact core system) directly to the nearest cell site associated with the TSP. The cell site may forward the registration request to the central AMF at the corresponding central core network system. The central AMF may perform a lookup at the registration data store in the central core network system and determine that the data associated with the compact core system is already stored. In this way, the compact core system is already pre-registered to operate with the central core network system. However, for registration to be complete after initiation, the central AMF may have to confirm or verify that the compact core system is indeed pre-registered, or already stored at the registration data store in the central core network system.

In yet another context, the compact core system may not be pre-registered with a TSP, and an operator of the compact core system may not have a user account with the TSP or a subscription plan for the compact core system. In this case, the central AMF may receive the registration request, and then determine that the data associated with the compact core system is not stored at the registration data store, and that the UDM does not maintain a user account associated with the operator of the compact core system. The central AMF may then add the data associated with the compact core system to the registration data store at the central core network system to complete the registration of the compact core system (the data associated with the compact core system may already be stored at the registration data store of the compact core system).

In an embodiment, once the compact AMF and the central AMF have completed the registration process, the compact AMF and the central AMF may communicate through one or more UPFs (at both the compact core system and the central core network system). In an embodiment, the compact AMF may use the NSSF at the compact core system (and the central AMF may use the NSSF at the central core network system) to establish a secure network slice for all communications between the compact AMF and the central

AMF, to provide an enhanced layer of security for the communications flowing between the compact AMF and the central AMF. The NSSF may establish the network slice by identifying the appropriate slice (or establishing a new slice) based on service requirements of the compact core system and the data associated with the compact core system. The NSSF may then provide slice selection information to the respective AMF. The AMF may coordinate with the SMF to ensure that communication sessions are properly managed and that user traffic is routed through the correct UPF associated with the designated network slice, ensuring the predefined security and quality of service (QOS) requirements for the compact core system are met. The network slice may be a dedicated, newly created network slice for communications between the compact AMF and the central AMF, or the network slice may be an existing network slice that meets the security and QoS requirements.

Once the network slice is created between the central AMF and the compact AMF using the UPFs, the compact AMF may communicate with the central AMF on an as needed basis to provide services to the UEs/devices attached to the compact core system. For example, the compact AMF may receive a session establishment request from a UE to establish a session between the UE and an external system. When the compact core system does not locally maintain policies related to the UE, the compact AMF may transmit a policy request over the network slice using the UPF to the central AMF at the central core network system, to request policies related to the UE. The policies may define rules and criteria for managing network resources, QoS, and user access based on various conditions, a subscription plan associated with the UE, requested services, current network conditions, etc. The central AMF may communicate with the PCF at the central core network system to obtain the policies for the UE and transmit the polices back to the compact AMF over the network slice using the UPF. The compact AMF may forward the session establishment request and the policies to the compact SMF at the compact core system, and the compact SMF may configure another UPF with forwarding rules according to the policies. The UPF may then create a user plane to route traffic between the UE and the external system.

In another embodiment, the compact core system may use rules to determine whether and when to transmit certain types of data to the central core network system. For example, the compact core system may collect data usage statistics related to a particular session with a connected UE or more generally related to the usage of the compact core system. The compact core system may be programmed with a rule indicating that the data usage statistics are to be transmitted to the central core network for billing/charging purposes according to a predefined schedule or based on different types of trigger events. The compact AMF may transmit the data usage statistics to the central AMF at the central core network based on the rules. The central AMF may forward the data usage statistics to a charging function (CHF) at the central core network to perform billing-related tasks based on the data usage statistics. In other embodiments, the rules may govern the transmission of different types between the compact core system and the central core network system. For example, other types of data that are governed by the rules may include authentication/authorization data, policy data, local management data, operational data, network configuration data, etc.

In another embodiment, the network slice may be used during the handover process of a UE from the compact core system to the central core network system as well. For example, suppose the UE moves to a region outside the coverage area of the compact core system after the session with the external system is established. The compact AMF may detect that the UE has moved outside the coverage area and transmit a handover request to the central AMF over the network slice using the UPF. The central AMF may transmit a handover response back to the compact AMF over the network slice using the UPF, and then transmit an instruction to a target cell site nearest to the UE to execute the handover by initiating a connection with the UE. Meanwhile, the central AMF may transmit an instruction to a serving cell site of the UE to terminate the connection with the UE once the handover response is received.

In this way, the embodiments disclosed herein implement an automated registration and session management process by creating a secure network slice between the compact AMF and the central AMF. The embodiments disclosed herein also essentially remove the PRL database and the complex translation computations that may otherwise be performed during network transitions, handovers, or roaming procedures. Similarly, the embodiments disclosed enable a simple registration process with minimal communications back and forth between the compact core system and the central core network, thereby reducing network congestion and increasing network capacity.

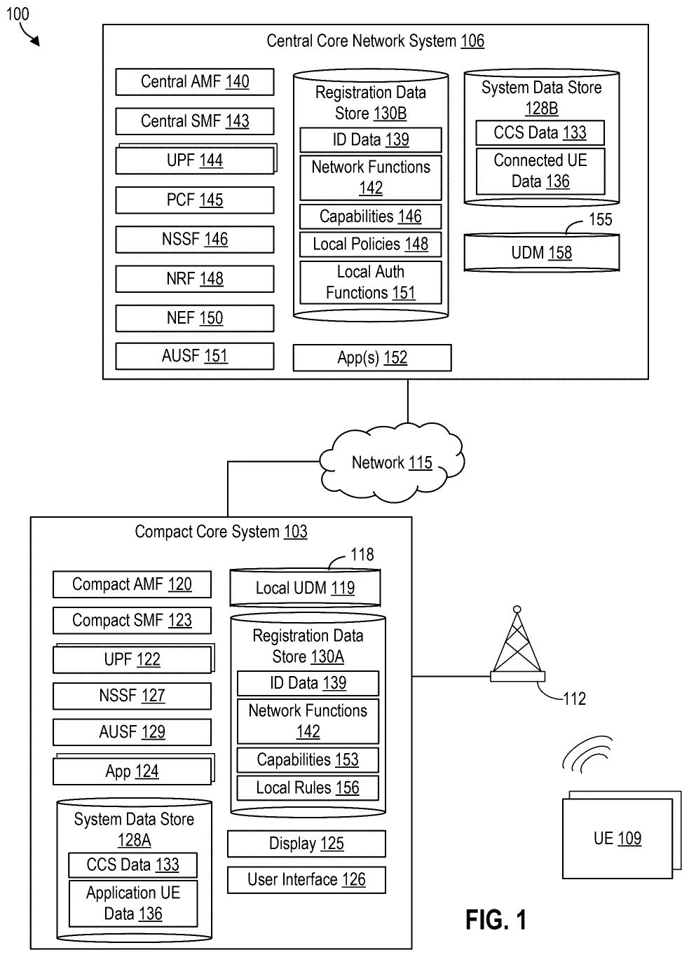

Turning now to FIG. 1, a communication network 100 is described. The communication network 100 includes a compact core system 103, a central core network system 106, a UE 109, a cell site 112, and a network 115. The communication network 100 shown in FIG. 1 may include a single compact core system 103, a single central core network system 106, a single UE 109, and a single cell site 112 for illustrative purposes only. However, it should be appreciated that the communication network 100 may include any number of compact core systems 103, central core network systems 106, UEs 109, and cell sites 112.

The UE 109 may be a device used by an end-user to communicate with a network 115, compact core system 103, and/or the central core network system 106, encompassing all hardware and software needed for connectivity. Examples of UEs 109 include, for example, cellular phones, smartphones, tablets, laptops, headset computers, wearable computers, Internet of Things (IoT) devices, and connected cars. The cell site 112 may provide a wireless communication link to the UE 109 according to a 5G, a long term evolution (LTE), a code division multiple access (CDMA), or a global system for mobile communications (GSM) wireless telecommunication protocol. The network 115 may be one or more private networks, one or more public networks, or a combination thereof. As should be appreciated, though the network 115 is shown as being separate from the central core network system 106, in some embodiments, the network 115 may include the central core network system 106.

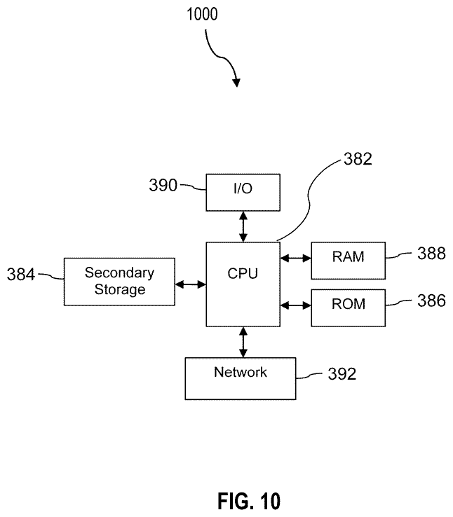

As mentioned above, a compact core system 103 may be embodied as one or more computer systems (e.g., computer systems 1000 of FIG. 10 as further described below). The compact core system 103 refers to a compact and scalable mobile core network solution designed for small to medium-sized operators, private networks, and specialized use cases such as Internet of Things deployments. The compact core system 103 may be a specialized, standalone computer system with a small footprint (e.g., a lightweight device positioned in a data center, university campus, business enterprise campus, etc.). Alternatively, the compact core system 103 may be embodied programmatically into other types of devices (e.g., UEs, IoT devices, reader devices, smart devices, modems, routers, etc.).

The compact core system 103 may include various hardware and software components that may be used to manage registration of UEs 109, authentication, session management, data routing, security and policy enforcement, etc. In an embodiment, the compact core system 103 may include a subset of the hardware and/or software resources in the central core network system 106.

For example, the compact core system 103 may include a compact AMF 120, a compact SMF 123, one or more UPFs 122, one or more applications 124, an NSSF 127, an AUSF 129, and other software modules also included in the central core network system 106 (as further described herein). The compact AMF 120 may manage registration, connection, and mobility with connected UEs 109 (e.g., UEs 109 connected with the compact core system 103), while the compact SMF 123 may handle session management, address allocation, and policy enforcement for the connected UEs 109. The one or more UPFs 122 may route and forward user data packets between the UE 109 and other systems/devices in the communication network 110. The NSSF 127 may be responsible for selecting the appropriate network slice for the compact core system 103 based on specific criteria and network policies, to ensure optimal resource allocation and performance. The AUSF 129 may be responsible for authenticating UEs 109 using the local UDM 119 and the compact AMF 120 to verify the identity of subscribers using various authentication methods. The AUSF 129 may use local authentication functions to verify the identity and credentials of UEs 109 connecting to the compact core system 103, using locally stored or cached data at the local UDM 119. This allows the compact core system 103 to independently authenticate UEs 109 without relying on the central core network system 106, enhancing responsiveness and reliability, especially in scenarios with limited connectivity to the central core network system 106. The one or more applications 124 may include instructions stored at one or more memories at the compact core system 103, which may be executable by one or more processors at the compact core system 103. The application(s) 124 may execute one or more of the functions of the compact AMF 120, compact SMF 123, UPFs 122, NSSF 127, or other software modules in the compact core system 103. While the embodiment of the compact core system 103 shown in FIG. 1 only shows the compact core system 103 as including the compact AMF 120, compact SMF 123, and the UPFs 122, it should be appreciated that different variations of the compact core system 103 may include one or more software modules from the central core network system 106 (e.g., the PCF, NRF, NEF, etc.).

The compact core system 103 may also include different data stores (e.g., one or more memories, distributed and/or co-located) used to collect data related to the registration, connection, and management of connected UEs 109. In an embodiment, the compact core system 103 includes the local UDM data store 118, the system data store 128A, and the registration data store 130A.

The local UDM data store 118 may be a data repository storing the local UDM 119. The local UDM 119 includes subscriber data, such as user profiles, authentication credentials, and subscription information. The local UDM 119 may facilitate user authentication, authorization, and mobility management by interacting with other core network functions, such as the compact AMF 120 and the AUSF 129 at the compact core system 103. The local UDM 119 may contain the subscriber data of substantially fewer users than the macro-scale UDM 158 at the central core network system 106. The local UDM 119 may be, for example, loaded after registration of the compact core system 103 with subscriber data of users residing within a predefined geographic range from the location of the compact core system 103. For example, the central AMF 140 may obtain and transmit the local subscriber data of users residing within a predefined geographic range from the location of the compact core system 103 to the compact AMF 120 after registration, and the compact AMF 120 may store the subscriber data in the local UDM 119.

The system data store 128A may include various types of data collected by the connected UEs 109 and the compact core system 103. In an embodiment, the system data store 128A may include compact core system data 133. For example, the compact core system data 133 may include session data (e.g., information describing the UEs 109, locations of the UEs 109, session states in association with the UEs 109, active bearers, and session establishment data (e.g., details related to the setup of sessions, QoS requirements for a session, service types provided in a session, session parameters, etc.)), authentication and authorization data (e.g., authorization and access tokens used to validate access by the UEs 109 to the compact core systems 103), policy data (e.g., policy rules for the UEs 109, including traffic management, bandwidth allocation, service prioritization, QoS parameters, etc., to ensure appropriate handling of traffic based on network policies, etc.), local management data (e.g., handover information, such as handover requests/responses, updates on the UE 109 or compact core system 103 location, etc.), operational data (e.g., performance metrics of the compact core system 103, such as network performance data including latency, throughput, packet loss, resource utilization, etc.), subscriber data (e.g., subscriber profiles associated with the UEs 109 and/or the compact core system 103, policy enforcement decisions based on subscriber profiles and service agreements, etc.), and/or network configuration data (e.g., configuration updates to synchronize network settings across the compact core system 103 to the central core network system 106, such as software patch upgrades and version management).

In an embodiment, the system data store 128A may also include application UE data 136. The application UE data 136 may include data obtained by applications of the UEs 109 that are shared with the compact core system 103 and stored at the system data store 128A in the compact core system 103. The compact core system data 133 may be associated with local rules 156 indicating conditions and rules governing when and how the compact core system 103 is to communicate back with central core network system 106.

In an embodiment, the registration data store 130A may include data pertaining to the hardware and software specs of the compact core system 103. For example, the registration data store 130A may store identification data 139, which may include an identifier of the compact core system 103 (e.g., a value uniquely identifying the compact core system 103), an address (e.g., Internet Protocol (IP) address) of the compact core system 103, and/or a location of the compact core system 103 (e.g., latitude and longitude coordinate of the compact core system 103). The registration data store 130A may also store the network functions 142 (e.g., identifications of the network functions 142) provisioned at the compact core system 103. For example, the network functions 142 provisioned at the compact core system 103 shown in FIG. 1 include the compact AMF 120, the compact SMF 123, the UPFs 122, the NSSF 127, the AUSF 129, and the applications 124.

The registration data store 130A may also store the capabilities 153 of the compact core system 103. The capabilities 153 may include, for example, capabilities to be deployed rapidly in various locations, enhanced security capabilities, enhanced privacy and/or encryption capabilities, edge computing capabilities, energy efficiency mechanisms, etc.

The registration data store 130A may also store local rules 156 and local authentication functions 151 provisioned at the compact core system 103, which the compact AMF 120 and the compact SMF 123 may be capable of enforcing. The local rules 156 may refer to specific rules and configurations governing data movement/sharing, network behavior, QoS, traffic management, and resource allocation tailored to the local environment. These local rules 156 may ensure permitted, efficient, and optimized service delivery by considering the unique requirements and constraints of the localized deployment area. For example, a local rule 156 may specify a predefined schedule, trigger event, and/or one or more conditions that may trigger the compact core system 103 to aggregate and transmit data to the central core network system 106.

In some embodiments, the compact core system 103 may also include a display 125 and a user interface 126 (e.g., touchscreen or keyboard/dialer). As further described herein, the operator of the compact core system 103 may use the user interface 126 to access an application or webpage associated with a TSP and enter security credentials to login to a user account at the compact core system 103.

The central core network system 106 may be embodied as one or more computer systems (e.g., computer systems 1000 of FIG. 10 as further described below). The central core network system 106 may be a distributed and interconnected collection of computer systems, servers, memories, processors, etc., that create a full-scale, centralized core network for handling extensive network management, control, and data processing tasks across a large geographical area, incorporating comprehensive functionalities. As shown in FIG. 1, the central core network system 106 may include a central AMF 140, a central SMF 143, one or more UPFs 144, a PCF 145, a NSSF 146, a NRF 148, a NEF 150, an AUSF 151, and one or more applications 152. The central AMF 140 may be similar to the compact AMF 120, except that the central AMF 140 manages a larger volume of UEs 109 over an extensive geographical coverage area to manage high levels of signaling traffic and complex mobility scenarios. The central AMF 140 may also be fully integrated with other central core network system 106 functionalities, and thus may require substantially more computational and storage resources to manage and process data at the larger scale, to ensure robust performance and redundancy.

The central SMF 143 may operate similar to the compact SMF 123, except that the central SMF 143 may also manage session control and data paths for a larger volume of UEs 109 over an extensive geographical coverage area. The central SMF 143 may also be fully integrated with other central core network system 106 functionalities, and thus may require substantially more computational and storage resources to manage and process data at the larger scale, to ensure robust performance and redundancy. The UPFs 144 may operate in the user plane to control traffic for UEs 109 connected to the central core network system 106.

The PCF 145 is responsible for managing policy rules and QoS parameters in the network 100, ensuring that resources are allocated according to predefined policies and service agreements. The NSSF 146 may be responsible for selecting appropriate network slices for UEs 109 based on service requirements and network conditions, enabling tailored network performance and functionality. The NRF 148 manages a repository of available network functions and their capabilities (e.g., and manages the registration data store 130B indicating available functions and capabilities at the compact core systems 103 in the network 100), allowing other network components to discover and communicate with these functions dynamically. The NEF 150 may provide a secure interface for external applications to interact with the central core network system 106, exposing network capabilities and services while managing security and policy compliance.

The central core network system 106 also includes a data store 155 to store the UDM 158. The UDM 158 may be a large-scale data repository storing user subscription data and profiles (e.g., for UEs 109 and compact core systems 103), providing essential information for authentication, authorization, and service provisioning. The UDM 158 may include subscription data for far more user accounts than the local UDM 119 in the compact core system 103. The AUSF 151 may handle the authentication processes for UEs 109 and/or compact core systems 103 by verifying security credentials and ensuring secure access to the central core network system 106 using the UDM 158.

As shown in FIG. 1, the central core network system 106 may include the registration data store 130B, which may maintain the same data as the registration data store 130A. The central core network system 106 may maintain a registration data store 130B for multiple compact core systems 103 in the network 100. Similarly, the central core network system 106 may include the system data store 128B, which may maintain some of the same data as the system data store 128A of the compact core system 103 (e.g., based on the permissions of sharing data between the system data store 128A and the system data store 128B). For example, the system data store 128B at the central core network system 106 may include data from the system data store 128A that is permitted to be shared according to a policy associated with the data or the UE 109. The central core network system 106 may maintain a system data store 128B for multiple compact core systems 103 in the network 100.

In an embodiment, the central core network system 106 and the compact core system 103 may have access to an external system in which a predictive or machine learning model has been provisioned. The central core network system 106 and/or the compact core system 103 may feed data to the model to train the model to generate outputs with recommendations and/or suggestions based on a threshold confidence score. The generated outputs may be used to perform various tasks as disclosed herein. For example, in some cases, model may have been trained with historical data on prior registered compact core systems 103, the network functions/databases provisioned at the compact core systems 103, etc. In this case, the central core network system 106 may input current data associated with the compact core system 103 into the model to output predicted network functions/databases to provision at the compact core system 103.

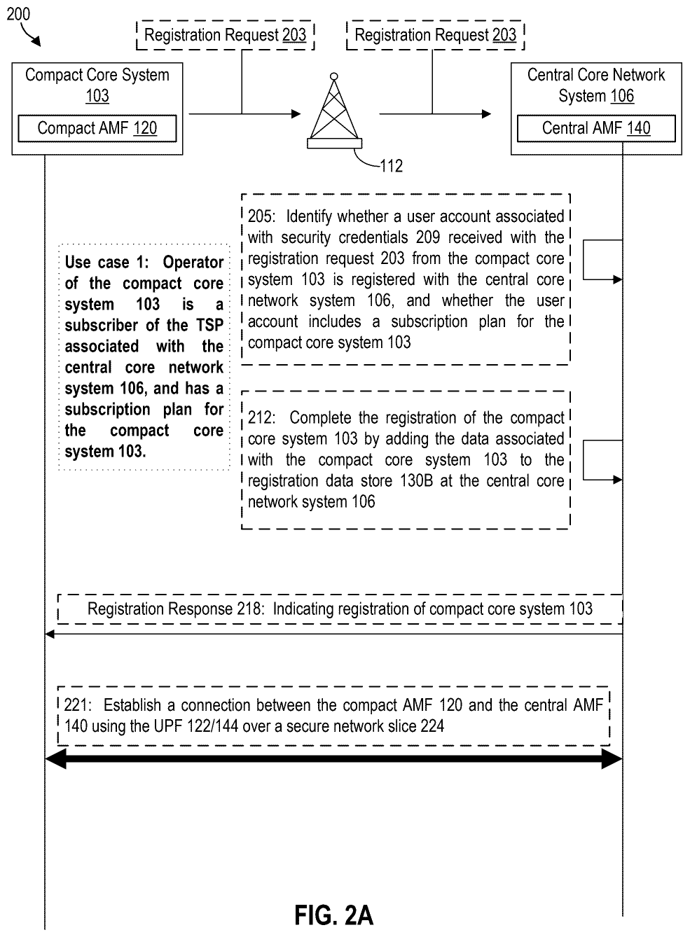

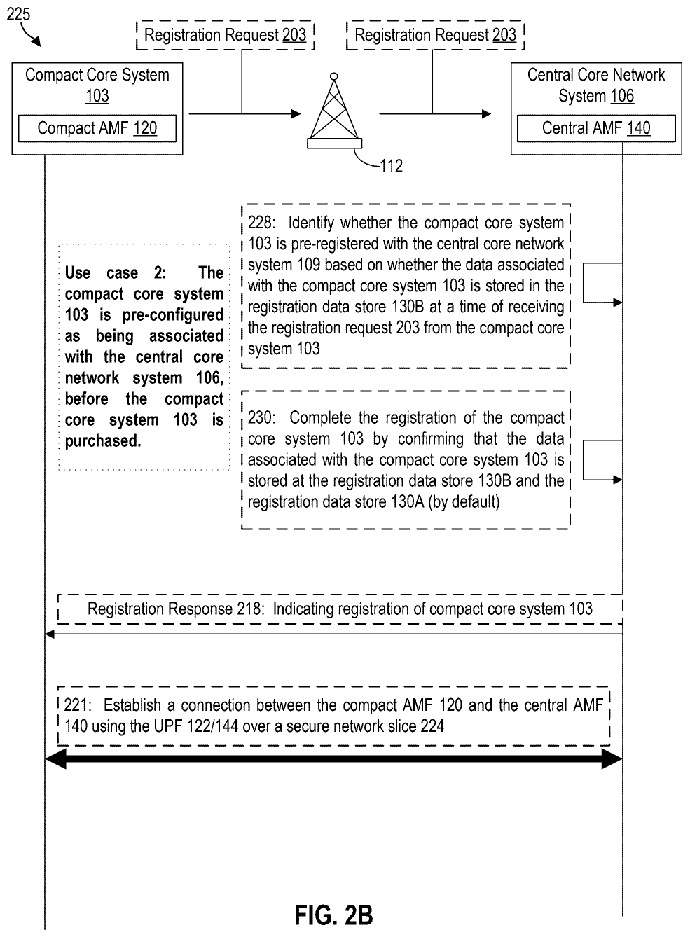

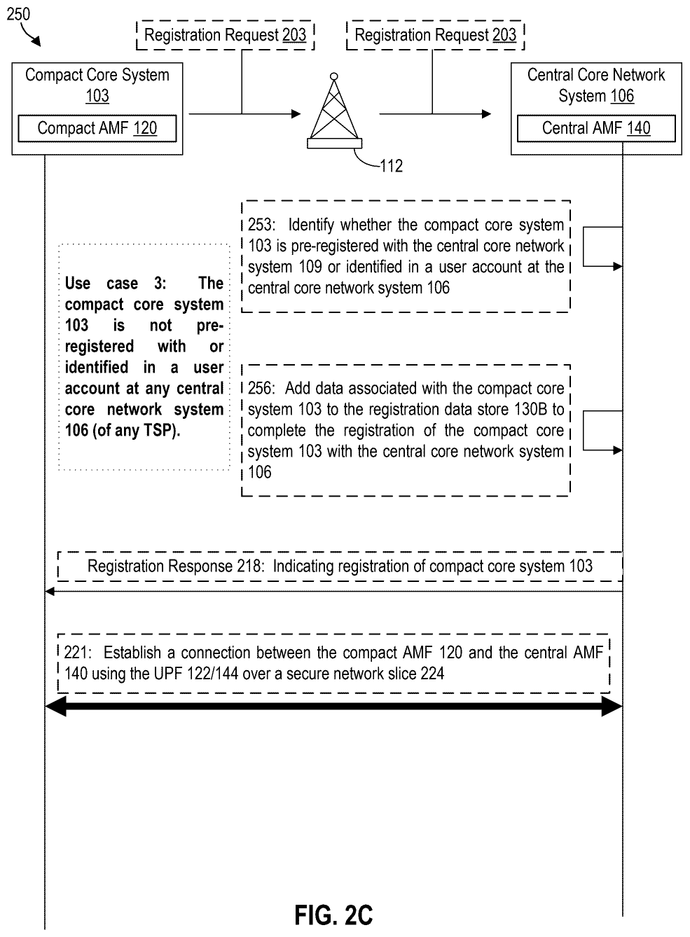

Referring now to FIGS. 2A, 2B, and 2C, shown are block diagrams illustrating methods for compact core system 103 registration using a secure connection with a central core network system 106 in the communication system of FIG. 1 according to various embodiments of the disclosure. In particular, each embodiment of compact core registration shown in FIGS. 2A, 2B, and 2C may be based on a different context of the compact core system 103. FIG. 2A illustrates a method 200 for registering the compact core system 103 when an operator of the compact core system 103 is a subscriber of the TSP associated with the central core network system 106, and the operator pays for a subscription plan in association with the compact core system 103. FIG. 2B illustrates a method 225 for registering the compact core system 103 when the compact core system 103 is pre-configured to be associated with a single TSP at initiation of the compact core system 103. FIG. 2C illustrates a method 250 for registering the compact core system 103 when the compact core system 103 is not pre-registered with a TSP and an operator of the compact core system 103 may not have a user account with the TSP or a subscription plan for the compact core system 103.

Turning specifically now to FIG. 2A, shown is a method 200 for performing a registration of the compact core system 103 according to various embodiments of the disclosure. As mentioned above, method 200 is directed to the use case in which an operator of the compact core system 103 is a subscriber of the TSP associated with the central core network system 106. The operator may have pre-paid or be subscribed to be billed for a subscription plan specifically for the services, policies, and functions provided by the compact core system 103. The operator may purchase a TSP-agnostic compact core system 103 that is not associated with a specific central core network system 106.

In this embodiment, the compact core system 103 may include a display 125 and a user interface 126 (e.g., via a touchscreen of the display or via a keyboard of the system 103). The operator may access an application or webpage associated with the subscribed-for TSP at the compact core system 103 and enter security credentials 209 (e.g., a username and password) into the compact core system 103 via the user interface 126.

The compact AMF 120 may obtain the entered security credentials 209 and generate a registration request 203. The registration request 203 may include security credentials and data associated with the compact core system 103. The data associated with the compact core system 103 may include identification data 139 of the compact core system 103 (e.g., value identifying the compact core system 103, location, etc.), network functions 142 provisioned at the compact core system 103 (e.g., the compact AMF 120, the compact SMF 123, the UPFs 122, and other software modules of the compact core system 103, etc.), one or more hardware or software capabilities 153 of the compact core system 103, local rules 156 at the compact core system 103, authentication functions provisioned at the compact core system 103, data stores 128A and 130A provisioned at the compact core system 103, etc. The compact AMF 120 may transmit the registration request 203 to the nearest cell site 112 associated with the subscribed-for TSP. The cell site 112 may forward the registration request 203 to the central AMF 140 at the central core network system 106.

At operation 205, the central AMF 140 may identify whether a user account associated with the received credentials 209 is registered with the central core network system 106, and whether the user account includes a subscription plan for the compact core system 103 identified in the registration request 203. For example, the central AMF 140 may perform a lookup at the UDM 158 and in some cases, the registration data store 130B, to identify whether a user account associated with the received credentials 209 is registered with the central core network system 106, and whether the user account includes a subscription plan for the compact core system 103 identified in the registration request 203. For example, the UDM 158 may include data associated with the subscription plan purchased by the operator of the compact core system 103. The central AMF 140 and the AUSF 151 may verify the security credentials 209 with a user account at the central core network system 106 using the UDM 158.

When the central AMF 140 identifies the user account, at operation 212, the central AMF 140 may add the data associated with the compact core system 103 (received in the registration request 203) to the registration data store 130B at the central core network system 106. At this point, the compact core system 103 may already store the data associated with the compact core system 103 at the registration data store 130A within the compact core system 103. When the compact core system 103 and the central core network system 106 both maintain the data associated with the compact core system 103, the registration of the compact core system 103 may be considered complete.

Once registration is complete, the central AMF 140 at the central core network system 106 may transmit a registration response 218 to the compact AMF 120 at the compact core system 103. The registration response 218 may indicate that the registration of the newly purchased compact core system 103 of the subscriber is complete.

Once the compact AMF 120 and the central AMF 140 have completed the registration process, the compact AMF 120 and the central AMF 140 may communicate through one or more UPFs 122/144 (at both the compact core system 103 and the central core network system 106). At operation 221, the compact AMF 120 may use the NSSF 127 at the compact core system 103 (and the central AMF 140 may use the NSSF 146 at the central core network system 106) to establish a secure network slice 224 for all communications between the compact AMF 120 and the central AMF 140. The secure network slice 224 may ensure security of the communications flowing between the compact AMF 120 and the central AMF 140 by enforcing different enhanced security mechanisms (e.g., sophisticated encryption protocols, authentication methods, access controls, auditing, etc.). The NSSFs 127/146 may establish the network slice 224 by identifying the appropriate slice 224 based on service requirements and the data associated with the compact core system 103, then providing slice selection information to the respective AMF 120/140. The AMF 120/140 coordinates with the local SMF 123/143 to ensure that communication sessions between the compact core system 103 and the central core network system 106 are properly managed through the network slice 224. In this way, user traffic is routed through the correct UPF 122/144 associated with the designated network slice 224, ensuring the specific security and QoS parameters for communications between the compact core system 103 and the central core network system 106 are met. The network slice 224 may be dedicated and newly created for communications between the compact AMF 120 and the central AMF 140, or the network slice 224 may be a pre-existing network slice that meets the security and QoS requirements. Once the network slice 224 is established between the central AMF 140 and the compact AMF 120 using the UPFs 122/144, the compact AMF 120 may communicate with the central AMF 140 on an as needed basis to provide services to the UEs 109 connected to the compact core system 103.

Turning specifically now to FIG. 2B, shown is a method 225 for performing a registration of the compact core system 103 according to various embodiments of the disclosure. As mentioned above, method 225 is directed to the use case in which the compact core system 103 may be pre-configured to be associated with a single TSP.

Similar to method 200 of FIG. 2A, the compact AMF 120 of the compact core system 103 transmits a registration request 203 to the central AMF 140 of the central core network system 106 via a cell site 112. However, unlike method 200 of FIG. 2A, the operator may not have provided security credentials 209 that would be authenticated or associated with a user account (and thus, the registration request 203 may not include security credentials 209). In addition, the cell site 112 may be the nearest cell site 112 owned and operated by the TSP with which the compact core system 103 is pre-registered (e.g., the compact AMF 120 may be programmed to communicate only with cell sites 112 associated with the registered TSP).

At operation 228, after receiving the registration request 203, the central AMF 140 may identify whether the compact core system 103 is pre-registered with the central core network system 106. This identification may be based on whether the data associated with the compact core system 103 (e.g., the data carried in the registration request 203, including the identification data 139, network functions 142, capabilities 153, local rules 156, etc.) is stored in the registration data store 130B of the central core network system 106 in association with a single compact core system 103 at the time of receiving the registration request 203.

At operation 230, the central AMF 140 may confirm whether the data associated with the compact core system 103 is already maintained at the registration data store 130B of the central core network system 106 (and also by default maintained at the compact core system 103). When the data associated with the compact core system 103 is maintained at the both the compact core system 103 and the central core network system 106, the registration of the compact core system 103 may be considered complete.

When the registration is complete, the central AMF 140 of the central core network system 106 may transmit a registration response 218 back to the compact AMF 120 of the compact core system 103. At operation 221, the compact AMF 120 may use the NSSF 127 and the central AMF 140 may use the NSSF 146 to establish the secure network slice 224 between the compact AMF 120 and the central AMF 140, to secure communications between the compact AMF 120 and the central AMF 140 over the UPFs 122 and 144, as described above.

Turning specifically now to FIG. 2C, shown is a method 250 for performing a registration of the compact core system 103 according to various embodiments of the disclosure. As mentioned above, method 250 is directed to the use case in which the compact core system 103 is not pre-registered with or identified in a user account at any central core network system 106 (of any TSP).

Similar to method 200 of FIG. 2A, the compact AMF 120 of the compact core system 103 transmits a registration request 203 to the central AMF 140 of the central core network system 106 via the cell site 112. However, unlike method 200 of FIG. 2A, the operator may not have provided security credentials 209 that would be authenticated or associated with a user account (and thus, the registration request 203 may not include security credentials 209). And unlike method 225 of FIG. 2B, the cell site 112 need not be specifically associated with a pre-registered TSP. The central AMF 140 may instead transmit the registration request 203 to the nearest cell site 112, which may be associated with any TSP, and the cell site 112 may again forward the registration request 203 to the central AMF 140 at the associated central core network system 106.

After receiving the registration request 203, at operation 253, the central AMF 140 may identify whether the compact core system 103 is pre-registered with the central core network system 106 or identified in a user account at the central core network system 106. For example, the central AMF 140 may search the UDM 158 and/or the registration data store 130B to identify whether the compact core system 103 is pre-registered with the central core network system 106 or identified in a user account at the central core network system 106. The central AMF 140 may determine that the compact core system 103 is not pre-registered or associated with a user account of the central core network system 106.

At operation 256, the central AMF 140 may add the data associated with the compact core system 103 (e.g., received in the registration request 203) to the registration data store 130B. After the data associated with the compact core system 103 is stored at the central core network system 106 (and by default at the compact core system 103), then registration of the compact core system 103 may be considered complete.

When the registration is complete, the central AMF 140 of the central core network system 106 may transmit a registration response 218 back to the compact AMF 120 of the compact core system 103. At operation 221, the compact AMF 120 may use the NSSF 127 and the central AMF 140 may use the NSSF 146 to establish the secure network slice 224 between the compact AMF 120 and the central AMF 140, to secure communications between the compact AMF 120 and the central AMF 140 over the UPFs 122 and 144, as described above.

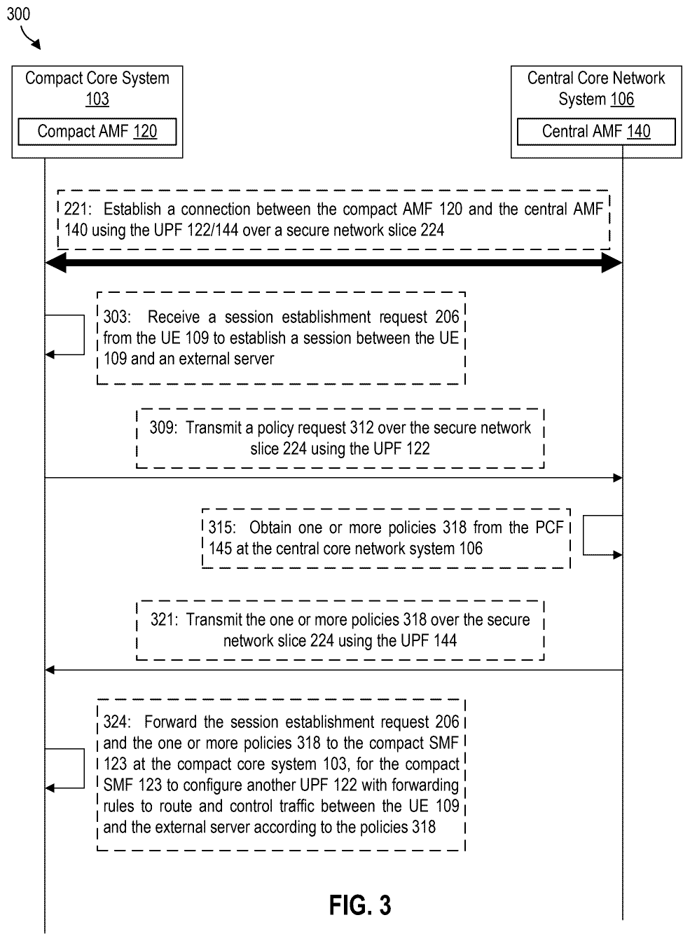

Referring now to FIG. 3, shown is a method 300 of using the network slice 224 during communications between the compact AMF 120 of the compact core system 103 and the central AMF 140 of the central core network system 106. Method 300 may begin after the compact core system 103 has registered with the central core network system 106, after the UE 109 has registered, authenticated, and connected with the compact core system 103, and after operation 221 in which the network slice 224 has been established to create a secure connection between the compact AMF 120 and the central AMF 140.

At operation 303, the compact AMF 120 may receive a session establishment request 206 from the UE 109 to establish a session between the UE 109 and an external system (e.g., a server from which to receive streaming content). The session establishment request 206 may include an identification of the UE 109 (e.g., MSISDN), an identification of the external system, and the desired QoS parameters requested by the UE 109. For example the requested session may be for a streaming content service, and the requested session may have certain QoS parameters associated with streaming content to provide optimal services to the user of the UE 109. The UE 109, being registered, authenticated, and connected to the compact core system 103, may be a subscriber of a TSP and may have a subscription plan with the QoS parameters and other parameters for the UE 109.

The compact core system 103 may not maintain the policies relevant for providing the requested services to the UE 109 according to the subscription plan of the UE 109. For example, in the embodiment shown in FIG. 3, the compact core system 103 may not include the PCF 145. Instead, the PCF 145 of the central core network system 106 may maintain one or more policies associated with the subscription plan (or other user account parameters for guaranteed services), current network conditions (e.g., network congestion, available bandwidth, latency, etc.), and the requested services (e.g., different services having different QoS parameters).

In this case, the compact AMF 120 may perform a lookup at the registration data store 130A to determine whether the compact core system 103 maintains policies for the UE 109. If not, the compact AMF 120 may perform operation 309, and transmit a policy request 312 to the central AMF 140, and this policy request 312 may be transmitted over the network slice 224 using the UPF 122. The policy request 312 may include an identifier or address of the UE 109 (e.g., the MSISDN of the UE 109) and an indication of the type of service requested (e.g., that the request is for policies 318 associated with the UE 109 for a streaming service).

At operation 315, the central AMF 140 may obtain one or more policies 318 associated with the UE 109 and the requested service (based on current network conditions) from the PCF 145 at the central core network system 106. At operation 321, the central AMF 140 may transmit the policies 318 over the network slice 224 using the UPF 144. At operation 324, the compact AMF 120 may forward the session establishment request 206 and the policies 318 to the compact SMF 123 at the compact core system 103. The compact SMF 123 may configure another UPF 122 with forwarding rules based on the policies 318 to control, manage, and route traffic between the UE 109 and the external system according to the policies 318.

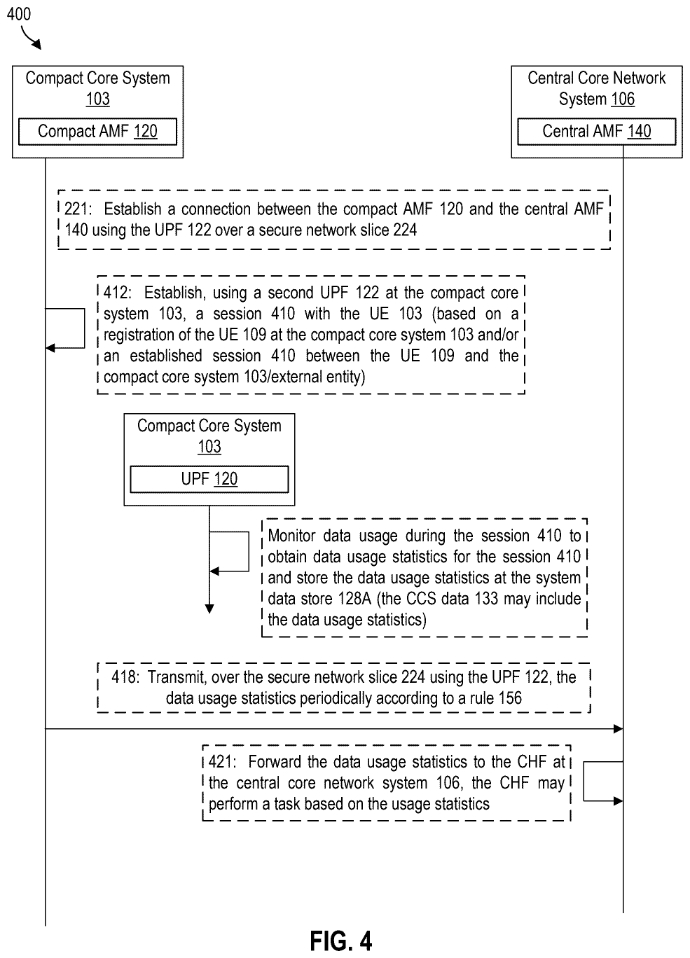

Referring now to FIG. 4, shown is a method 400 of using the network slice 224 during communications between the compact AMF 120 of the compact core system 103 and the central AMF 140 of the central core network system 106. Method 400 may begin after the compact core system 103 has registered with the central core network system 106, after the UE 109 has registered, authenticated, and connected with the compact core system 103, and after operation 221 in which the network slice 224 has been established to create a secure connection between the compact AMF 120 and the central AMF 140.

At operation 412, the compact AMF 120 may establish, using a second UPF 122 at the compact core system 103, a session 410 with the UE 109. In an embodiment, the establishment of the session 410 may be based on completion of the registration, authentication, and connecting of the UE 109 with the compact core system 103. In another embodiment, the establishment of the session 410 may also be based on the compact core system 103 completing establishment of the session 410 between the UE 109 and the compact core system 103 and/or an external entity.

At operation 415, the second UPF 122 of the compact core system 103 may monitor data usage during the session 410, which may be, for example, a streaming session. The monitored data usage collected over a period of time by the UE 109 may be aggregated into usage statistics for the UE 109. For example, the second UPF 122 may collect the usage statistics describing the amount of data being transmitted and other relevant metrics during the streaming session 410 for a predefined period of time.

In another embodiment, all of the active UPFs 122 of the compact core system 103 may monitor data usage during all sessions being performed using the compact core system 103 over a period of time, to generate compact core data usage statistics. The compact core data usage statistics may not be specific to a UE 109, but may instead be generalized for the usage of the compact core system 103 within the predefined period of time.

In either embodiment, the collected data usage statistics may be stored at the system data store 128A as part of the compact core system data 133. The compact core system 103 may operate according to the preprogrammed local rules 156, which may govern when the collected data usage statistics are to be securely transmitted to the central core network system 106. For example, a local rule 156 may indicate that the collected data usage statistics are to be transmitted to the central core network system 106 periodically according to a predefined schedule (e.g., every data, every 2 hours, etc.). In another embodiment, a local rule 156 may indicate that the collected data usage statistics are to be transmitted to the central core network system 106 in response to detecting a trigger event or a condition (e.g., when the session 410 terminates, when the session 410 updates to provide different streaming content to a UE, when the compact core system 103 is activated or deactivated, etc.).

In the example shown in FIG. 4, the compact AMF 120 may determine that the data usage statistics are to be transmitted to the central core network system 106 based on a local rule 156 provisioned at the system data store 128A. At operation 418, the compact AMF 120 may transmit the data usage statistics to the central AMF 140 over the network slice 224 using the first UPF 122.

At operation 421, the central AMF 140 may forward the data usage statistics to a charging function (CHF) at the central core network system 106. The CHF may perform various billing-related tasks based on the received data usage statistics. For example, when the data usage statistics are related to a particular session 410 with a UE 109, the billing-related tasks may include generating a billing record, updating charging rules for the user operating the UE 109, update billing records for the user operating the UE 109, etc. When the data usage statistics are related to the usage of the compact core system 103 (e.g., not related to a session 410 with a UE 109), the billing-related tasks may include generating a billing record for the customer/owner of the compact core system 103, updating charging rules for the customer/owner of the compact core system 103, etc.

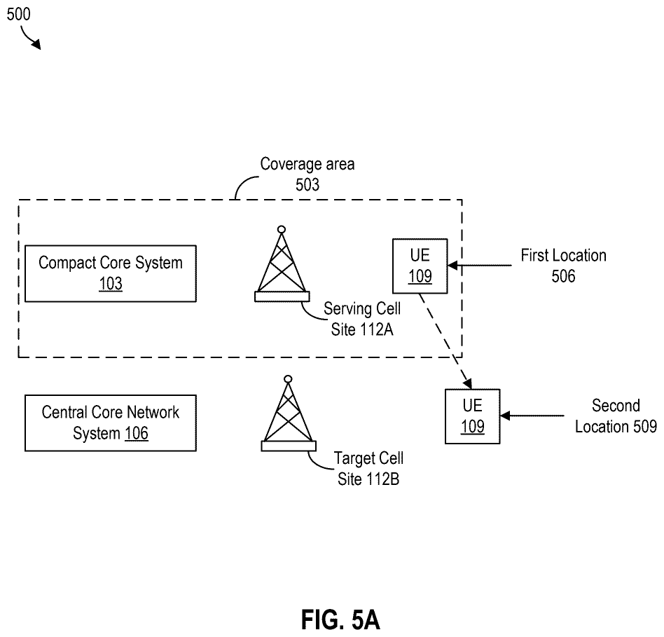

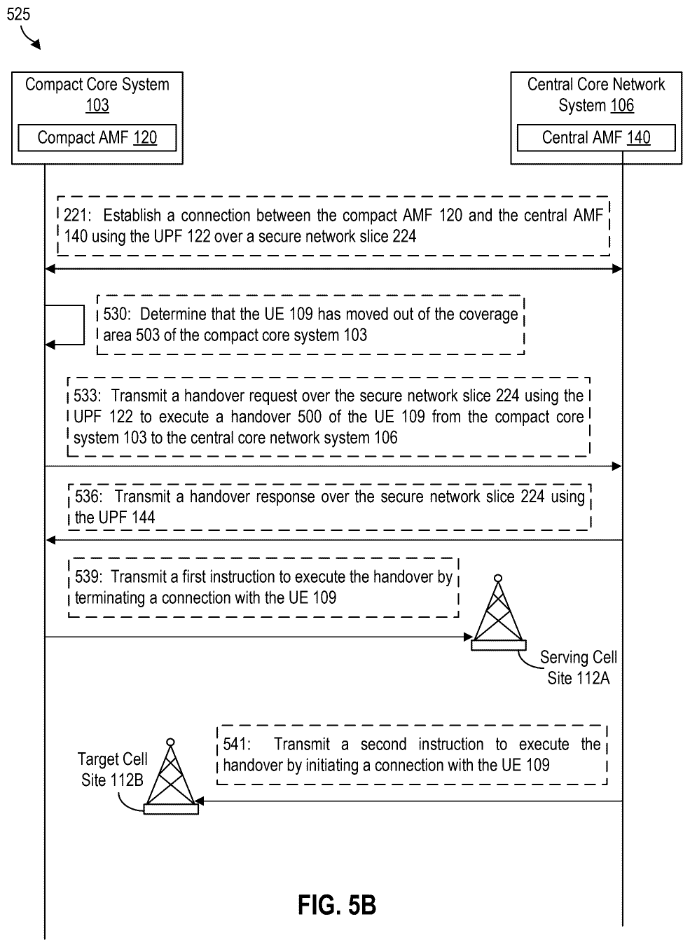

Referring now to FIG. 5A, shown is a handover 500 implemented in the communication network 100 when the UE 109 moves from the first location 506 to the second location 509. In an embodiment, the handover 500 may be initiated after the UE 109 has already registered, authenticated, and connected with the compact core system 103.

As shown in FIG. 5, the UE 109 is located at the first location 506 in a coverage area 503 of the compact core system 103 at a first time. The coverage area 503 of the compact core system 103 refers to the specific, localized geographical region where the compact core system 103 provides its network services, typically focusing on a smaller area such as a rural community, industrial site, or temporary event location. When the UE 109 is at the first location 506, the UE 109 is connected to the compact core system 103 via the serving cell site 112A. The serving cell site 112A may be a localized radio access point providing wireless connectivity to the UE 109 to facilitate communication between the UE 109 and the core network functions of the compact core system 103.

Subsequently, the UE 109 may move to a second location 509 outside the coverage area 503 of the compact core system 103. When the UE 109 is outside the coverage area 503 of the compact core system 103, the UE 109 may no longer be in a position to be wirelessly connected to the compact core system 103 and receive the benefits of the network functions of the compact core system 103.

In this case, the handover 500 may be initiated to terminate the connection from the UE 109 to the compact core system 103 via the serving cell site 112A, and instead establish a connection between the UE 109 and the central core network system 106 via a target cell site 112B. This handover may be performed seamlessly in a manner that is undetectable by the user of the UE 109. The target cell site 112B may be similar to the serving cell site 112A, except that the target cell site 112B may serve UEs 109 that are positioned outside the coverage area 503 of the compact core system 103.

Referring now to FIG. 5B, shown is a method 525 of performing the handover 500 of the UE 109 from the compact core system 103 to the central core network system 106 using the network slice 224. Method 525 may begin after the compact core system 103 has registered with the central core network system 106, after the UE 109 has registered, authenticated, and connected with the compact core system 103, and after operation 221 in which the network slice 224 has been established to create a secure connection between the compact AMF 120 and the central AMF 140 using the UPF 122.

At operation 530, the compact AMF 120 may determine that the UE 109 has moved out of the coverage area 503 of the compact core system 103. The compact AMF 120 determines that a UE 109 has gone outside the coverage area 503 by monitoring the UE 109 location updates, which are periodically reported by the UE 109. If the location updates indicate that the UE 109 is moving beyond the predefined geographical boundaries of the compact core system 103, coverage area 503, the compact AMF 120 may detect the need for the handover 500. This determination may be based on the comparison of a current location of the UE 109 with the coverage area 503 coordinates stored in the compact core system 103. Upon identifying that the UE 109 is outside the coverage area 503, the compact AMF 120 may initiate procedures to transfer the session to the appropriate central core network system 106 or another compact core system 103.

At operation 533, the compact AMF 120 may transmit a handover request to the central AMF 140 over the network slice 224 using the UPF 122 to execute the handover 500 of the UE 109 from the compact core system 103 to the central core network system 106. The central AMF 140 may receive the handover request and begin the process of the handover 500. The central AMF 140 may also, at operation 536, transmit a handover response to the compact AMF 120 over the network slice 224 using the UPF 144, indicating that the handover process has been initiated by the central core network system 106.

At operation 539, the compact AMF 120 may transmit a first instruction to the service cell site 112A (which is currently connected/attempting to connect to the UE 109 that has moved to the second location 509 outside the coverage area 503) using UPF 122. The first instruction may be to terminate the connection between the serving cell site 112A and the UE 109.

At operation 541, the central AMF 140 may transmit a second instruction to the target cell site 112B (which is not yet connected to the UE 109) using UPF 144. The second instruction may be to initiate the connection between the target cell site 112B and the UE 109.

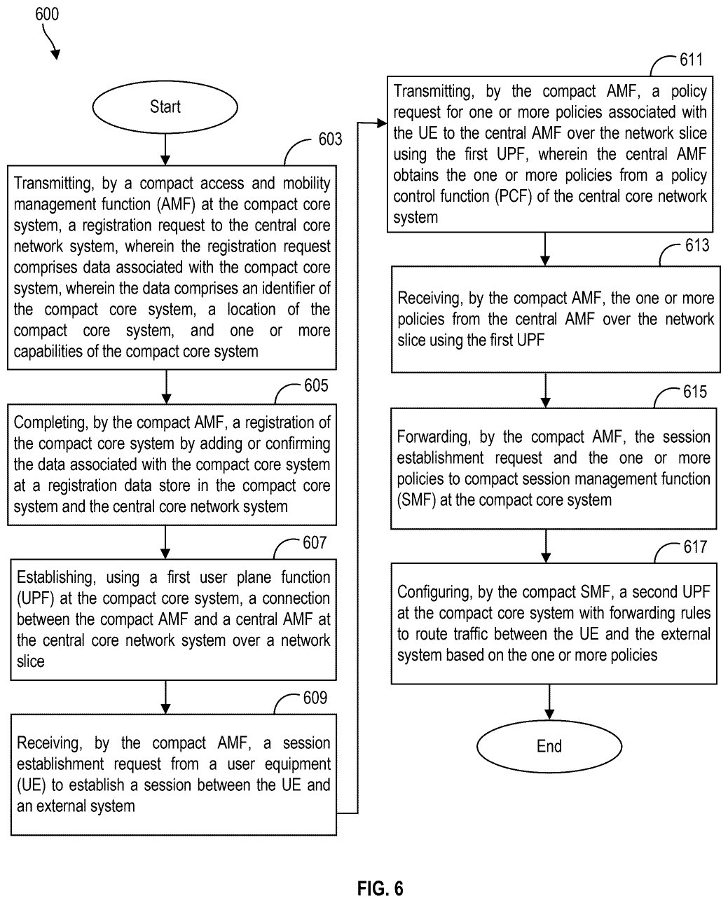

Referring now to FIG. 6, shown is a method 600 for compact core system 103 registration and session management using a secure connection with a central core network system 106 according to various embodiments of the disclosure. Method 600 may be performed by the compact core system 103, the central core network system 106, and the UE 109. As illustrated, method 600 of FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At step 603, method 600 comprises transmitting, by the compact AMF 120 at the compact core system 103, a registration request 203 to the central core network system 106. The registration request 203 comprises data associated with the compact core system 103, the data comprises an identifier/identification of the compact core system 103 (e.g., identification data 139), a location of the compact core system 103 (e.g., in the identification data 139), and one or more capabilities of the compact core system 103 (e.g., as indicated in the network functions 142 and/or capabilities 153).

At step 605, method 600 comprises completing, by the compact AMF 120, a registration of the compact core system 103 by adding or confirming the data associated with the compact core system 103 at a registration data store 130B in the compact core system 103 and the central core network system 106. At step 607, method 600 comprises establishing, using a first UPF 122 at the compact core system 103, a connection between the compact AMF 120 and a central AMF 140 at the central core network system 106 over a network slice 224.

At step 609, method 600 comprises receiving, by the compact AMF 120, a session establishment request 206 from a UE 109 to establish a session between the UE 109 and an external system. At step 611, method 600 comprises transmitting, by the compact AMF 120, a policy request 312 for one or more policies 318 associated with the UE 109 to the central AMF 140 over the network slice 244 using the first UPF 122. The central AMF 140 obtains the one or more policies 318 from a PCF 145 of the central core network system 106. At step 613, method 600 comprises receiving, by the compact AMF 120, the one or more policies 318 from the central AMF 140 over the network slice 224 using the first UPF 122. At step 615, method 600 comprises forwarding, by the compact AMF 120, the session establishment request 206 and the one or more policies 318 to compact SMF 123 at the compact core system 103. At step 617, method 600 comprise configuring, by the compact SMF 123, a second UPF 122 at the compact core system 103 with forwarding rules to route traffic between the UE 109 and the external system based on the one or more policies 318.

Method 600 may include other steps and features not otherwise shown in FIG. 6. In an embodiment, the registration of the compact core system 103 is performed by adding the data associated with the compact core system 103 at the registration data store 130B when security credentials 209 are received from an operator of the compact core system 103 and authenticated. The security credentials 209 are associated with a user account and a subscription plan stored association with the identifier of the compact core system 103. In another embodiment, the registration of the compact core system 103 is performed by confirming that the data associated with the compact core system 103 is stored at the registration data store 130B when the compact core system 103 is pre-registered with the central core network system 106. In yet another embodiment, registration of the compact core system 103 is performed by adding the data associated with the compact core system 103 at the registration data store 130B when the compact core system 103 is not pre-registered with the central core network system 106 and when the compact core system 103 is not associated with a user account or subscription plan.

In an embodiment, the network slice 224 may be a dedicated network slice for communications between one or more compact core systems 103 and the central core network system 106. The network slice 224 employs at least one of encryption protocols, authentication mechanisms, access controls, or auditing.

In an embodiment, after establishing, using the first UPF 122, the connection between the compact AMF 120 and the central AMF 140, the method 600 further comprises transmitting, by the compact AMF 120, the data associated with the compact core system 103 to the central AMF 140. The data associated with the compact core system 103 comprises at least one of the identifiers of the compact core system 103, the location of the compact core system 103, the one or more capabilities of the compact core system 103, or one or more rules governing session establishment and management at the compact core system 103.

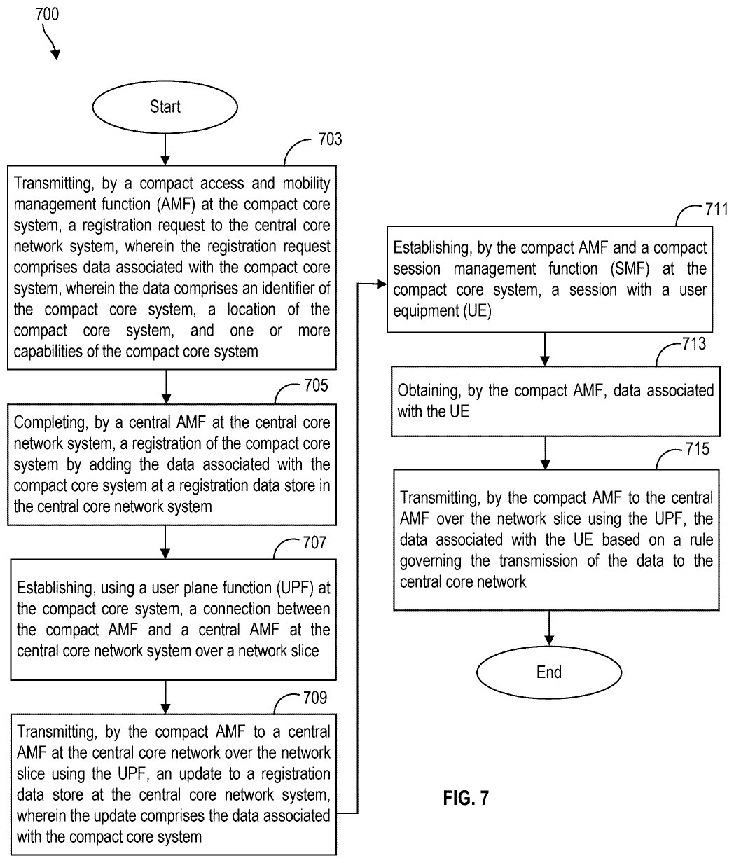

Referring now to FIG. 7, shown is a method 700 for compact core system 103 registration and session management using a secure connection with a central core network system 106 according to various embodiments of the disclosure. Method 700 may be performed by the compact core system 103, the central core network system 106, and the UE 109. As illustrated, method 700 of FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At step 703, method 700 comprises transmitting, by the compact AMF 120 at the compact core system 103, a registration request 203 to the central core network system 106. The registration request 203 comprises data associated with the compact core system 103, the data comprises an identifier/identification of the compact core system 103 (e.g., identification data 139), a location of the compact core system 103 (e.g., in the identification data 139), and one or more capabilities of the compact core system 103 (e.g., as indicated in the network functions 142 and/or capabilities 153).

At step 705, method 700 comprises completing, by the central AMF 140, a registration of the compact core system 103 by adding the data associated with the compact core system 103 at a registration data store 130B in the central core network system 106. At step 707, method 700 comprises establishing, using a UPF 122 at the compact core system 103, a connection between the compact AMF 120 and a central AMF 140 at the central core network system 106 over a network slice 224.

At step 709, method 700 comprises transmitting, by the compact AMF 120 to the central AMF 140 over the network slice 224 using the UPF 122, an update to a registration data store 130B at the central core network system 106. The update comprises the data associated with the compact core system 103. At step 711, method 700 comprises establishing, by the compact AMF 120 and a compact session management function (SMF) 123 at the compact core system 103, a session with a user equipment (UE) 109. At step 713, method 700 comprises obtaining, by the compact AMF 120, data (e.g., data 133 or application UE data 136) associated with the UE 109. At step 715, method 700 comprises transmitting, by the compact AMF 120 to the central AMF 140 over the network slice 224 using the UPF 122, the data (e.g., data usage statistics stored at the data 133 of the system data store 128A) associated with the UE 109 based on a local rule 156 governing the transmission of the data to the central core network.

Method 700 may include other steps and/or features that are not otherwise shown in FIG. 7. In an embodiment, registration of the compact core system 103 is performed by adding the data associated with the compact core system 103 at the registration data store 130B when the compact core system 103 is not pre-registered with the central core network system 106 and when the compact core system 103 is not associated with a user account or subscription plan. In an embodiment, the data associated with the UE 109 (e.g., the data 133 and/or application UE data 136) may include at least one of session data, authentication and authorization data, policy data, location management data, operational data, subscriber data, or network configuration data.

In an embodiment, the network slice 224 may be a dedicated network slice for communications between one or more compact core systems 103 and the central core network system 106. The network slice 224 employs at least one of encryption protocols, authentication mechanisms, access controls, or auditing.

In an embodiment, after establishing, using the first UPF 122, the connection between the compact AMF 120 and the central AMF 140, the method 700 further comprises transmitting, by the compact AMF 120, the data associated with the compact core system 103 to the central AMF 140. The data associated with the compact core system 103 comprises at least one of the identifiers of the compact core system 103, the location of the compact core system 103, the one or more capabilities of the compact core system 103, or one or more rules governing session establishment and management at the compact core system 103.

In an embodiment, establishing, by the compact AMF 120 and the compact SMF 123 at the compact core system 103, a session with the UE 109 comprises receiving, by the compact AMF 120, a session establishment request 206 from the UE 109 to establish the session between the UE 109 and an external system, configuring, by the compact SMF 123, a second UPF 122 at the compact core system 103 with forwarding rules to route traffic between the UE 109 and the external system, and establishing, by the second UPF 122, a data path for user plane traffic between the UE 109 and the external system. In another embodiment, establishing, by the compact AMF 120 and the compact SMF 123 at the compact core system 103, a session with the UE 109 comprises completing a UE registration between the UE 109 and the compact core system 103.

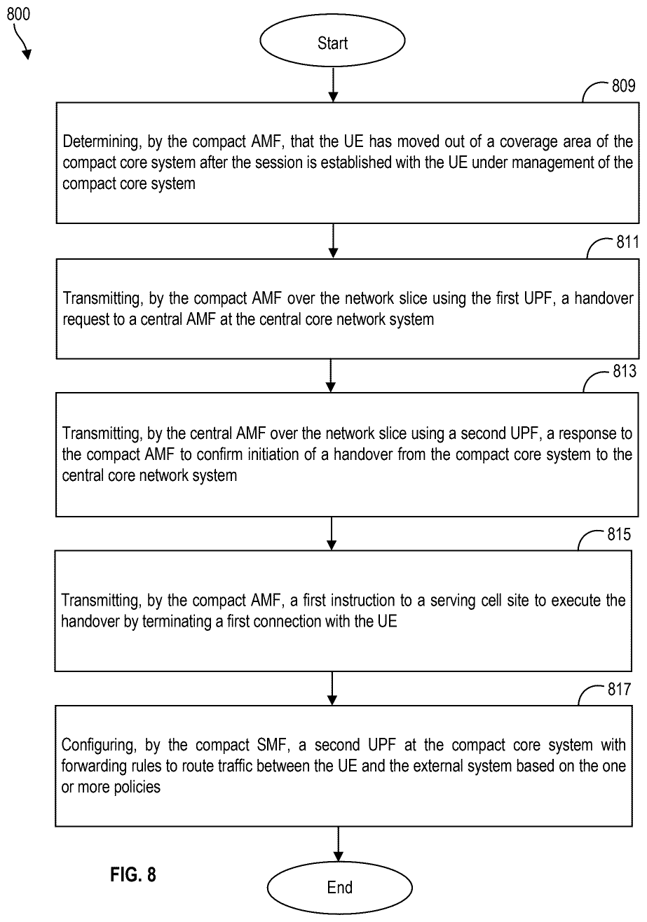

Referring now to FIG. 8, shown is a method 800 for compact core system 103 registration and session management using a secure connection with a central core network system 106 according to various embodiments of the disclosure. Method 800 may be performed by the compact core system 103, the central core network system 106, and the UE 109. As illustrated, method 800 of FIG. 8 includes a number of enumerated operations, but embodiments of the operations in FIG. 8 may include additional operations before, after, and in between the enumerated operations. In some embodiments, one or more of the enumerated operations may be omitted or performed in a different order.

At step 809, method 800 comprises determining, by the compact AMF 120, that the UE 109 has moved out of a coverage area 503 of the compact core system 103 after the session is established with the UE 109 under management of the compact core system 103. At step 811, method 800 comprises transmitting, by the compact AMF 120 over the network slice 224 using the first UPF 122, a handover request to a central AMF 140 at the central core network system 106. At step 813, method 800 comprises transmitting, by the central AMF 140 over the network slice 224 using a second UPF 144, a response to the compact AMF 120 to confirm initiation of a handover 500 from the compact core system 103 to the central core network system 106.

At step 815, method 800 comprises transmitting, by the compact AMF 120, a first instruction to a serving cell site 112A to execute the handover 500 by terminating a first connection with the UE 109. At step 817, method 800 comprises transmitting, by the central AMF 140, a second instruction to a target cell site 112B to execute the handover 500 by initiating a second connection with the UE 109 to continue the session under management of the central core network system 106.

Method 800 may include other steps and/or features that are not otherwise shown in FIG. 8. In an embodiment, before step 809, method 800 may comprises completing, by the compact AMF 120, a registration of the compact core system 103 by adding or confirming the data associated with the compact core system 103 at a registration data store 130B in the compact core system 103 and the central core network system 106, establishing, using a UPF 122 at the compact core system 103, a connection between the compact AMF 120 and a central AMF 140 at the central core network system 106 over a network slice 224, and/or establishing, by the compact AMF 120 and a compact SMF 123 at the compact core system 103, a session with a UE under management of the compact core system 103. In an embodiment, the registration is completed in response to a registration request 203. The registration request 203 comprises data associated with the compact core system 103. The data comprises an identifier of the compact core system 103, a location of the compact core system 103, and one or more capabilities of the compact core system 103.

In an embodiment, establishing, by the compact AMF 120 and the compact SMF 123 at the compact core system 103, a session with the UE 109 comprises receiving, by the compact AMF 120, a session establishment request 206 from the UE 109 to establish the session between the UE 109 and an external system, configuring, by the compact SMF 123, a second UPF 122 at the compact core system 103 with forwarding rules to route traffic between the UE 109 and the external system, and establishing, by the second UPF 122, a data path for user plane traffic between the UE 109 and the external system. In another embodiment, establishing, by the compact AMF 120 and the compact SMF 123 at the compact core system 103, a session with the UE 109 comprises completing a UE registration between the UE 109 and the compact core system 103.

In an embodiment, completing the registration of the compact core system 103 comprises transmitting, by the compact AMF 120, a registration request 203 to the central core network system 106, the registration request 203 comprising data associated with the compact core system 103. In an embodiment, after establishing, using the first UPF 122, the connection between the compact AMF 120 and the central AMF 140, the method 700 further comprises transmitting, by the compact AMF 120, the data associated with the compact core system 103 to the central AMF 140. The data associated with the compact core system 103 comprises at least one of the identifiers of the compact core system 103, the location of the compact core system 103, the one or more capabilities of the compact core system 103, or one or more rules governing session establishment and management at the compact core system 103.

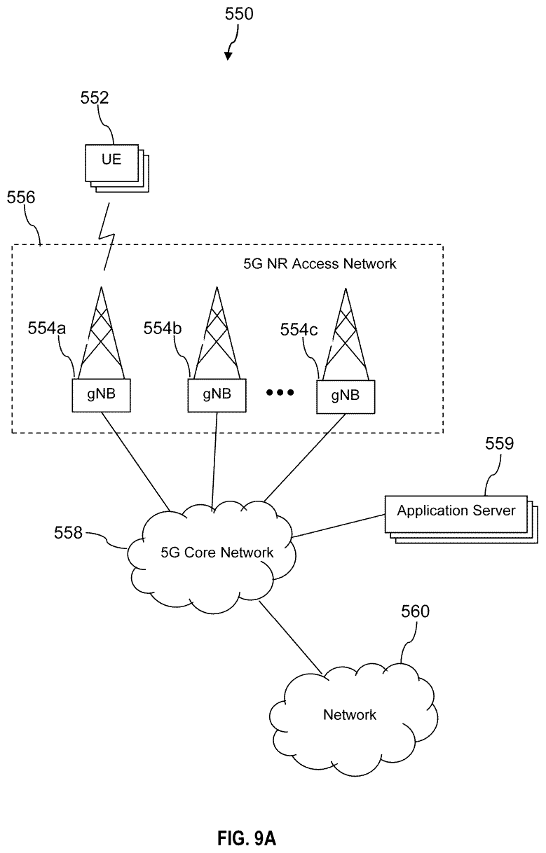

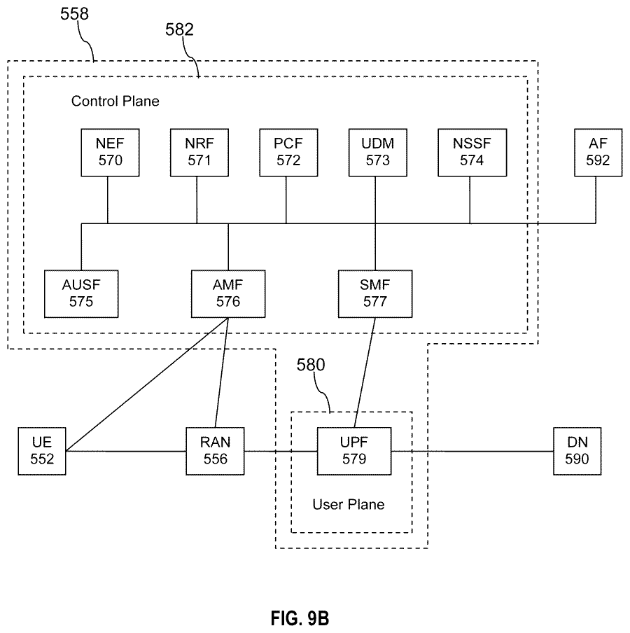

Turning now to FIG. 9A, an exemplary communication system 550 is described. In an embodiment, the communication system 550 may be implemented in the network 100 of FIG. 1. The communication system 550 includes a number of access nodes 554 that are configured to provide coverage in which UEs 552, such as cell phones, tablet computers, machine-type-communication devices, tracking devices, embedded wireless modules, and/or other wirelessly equipped communication devices (whether or not user operated), or devices such as UE 109 and compact core system 103 can operate. The access nodes 554 may be said to establish an access network 556. The access network 556 may be referred to as RAN in some contexts. In a 5G technology generation an access node 554 may be referred to as a gigabit Node B (gNB). In 4G technology (e.g., LTE technology) an access node 554 may be referred to as an eNB. In 3G technology (e.g., CDMA and GSM) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, the core network 558 described in FIGS. 5A-B may be similar to the central core network system 106 (e.g., the larger-scaled core network) and in some cases, similar to the compact core network system 106 (e.g., may include similar network functions, but on a smaller scale).

In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”-such as Long Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 9B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 6A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

FIG. 10 illustrates a computer system 1000 suitable for implementing one or more embodiments disclosed herein. In an embodiment, the UE 109 and/or the compact core system 103 may each be implemented as the computer system 1000. The computer system 1000 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 1000, at least one of the CPU 382, the RAM 388, and the ROM 386 are changed, transforming the computer system 1000 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 1000 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 1000 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 1000 to provide the functionality of a number of servers that is not directly bound to the number of computers in the computer system 1000. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 1000, at least portions of the contents of the computer program product to the secondary storage 384, to the ROM 386, to the RAM 388, and/or to other non-volatile memory and volatile memory of the computer system 1000. The processor 382 may process the executable instructions and/or data structures in part by directly accessing the computer program product, for example by reading from a CD-ROM disk inserted into a disk drive peripheral of the computer system 1000. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 1000.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 1000 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network between a compact core system and a central core network system for registration and session management, wherein the method comprises:
transmitting, by a compact access and mobility management function (AMF) at the compact core system, a registration request to the central core network system, wherein the registration request comprises data associated with the compact core system, wherein the data comprises an identifier of the compact core system, a location of the compact core system, and one or more capabilities of the compact core system;
completing, by the compact AMF, a registration of the compact core system by adding or confirming the data associated with the compact core system at a registration data store in the compact core system and the central core network system;
establishing, using a first user plane function (UPF) at the compact core system, a connection between the compact AMF and a central AMF at the central core network system over a network slice;
receiving, by the compact AMF, a session establishment request from a user equipment (UE) to establish a session between the UE and an external system;
transmitting, by the compact AMF, a policy request for one or more policies associated with the UE to the central AMF over the network slice using the first UPF, wherein the central AMF obtains the one or more policies from a policy control function (PCF) of the central core network system;
receiving, by the compact AMF, the one or more policies from the central AMF over the network slice using the first UPF;
forwarding, by the compact AMF, the session establishment request and the one or more policies to compact session management function (SMF) at the compact core system; and
configuring, by the compact SMF, a second UPF at the compact core system with forwarding rules to route traffic between the UE and the external system based on the one or more policies.

2. The method of claim 1, wherein the registration of the compact core system is performed by adding the data associated with the compact core system at the registration data store when security credentials are received from an operator of the compact core system and authenticated, wherein the security credentials are associated with a user account and a subscription plan stored in association with the identifier of the compact core system.

3. The method of claim 1, wherein the registration of the compact core system is performed by confirming that the data associated with the compact core system is stored at the registration data store when the compact core system is pre-registered with the central core network system.

4. The method of claim 1, wherein registration of the compact core system is performed by adding the data associated with the compact core system at the registration data store when the compact core system is not pre-registered with the central core network system and when the compact core system is not associated with an account or subscription plan.

5. The method of claim 1, wherein the network slice may be a dedicated network slice for communications between one or more compact core systems and the central core network system, and wherein the network slice employs at least one of encryption protocols, authentication mechanisms, access controls, or auditing.

6. The method of claim 1, wherein after establishing, using the first UPF, the connection between the compact AMF and the central AMF, the method further comprises transmitting, by the compact AMF, the data associated with the compact core system to the central AMF, wherein the data associated with the compact core system comprises at least one of the identifier of the compact core system, the location of the compact core system, the one or more capabilities of the compact core system, or one or more rules governing session establishment and management at the compact core system.

7. The method of claim 1, wherein after the second UPF is configured, the method further comprises establishing, by the second UPF, a data path for user plane traffic between the UE and the external system.

8. A method implemented in a communication network between a compact core system and a central core network system for registration and session management, wherein the method comprises:
transmitting, by a compact access and mobility management function (AMF) at the compact core system, a registration request to the central core network system, wherein the registration request comprises data associated with the compact core system, wherein the data comprises an identifier of the compact core system, a location of the compact core system, and one or more capabilities of the compact core system;
completing, by a central AMF at the central core network system, a registration of the compact core system by adding the data associated with the compact core system at a registration data store in the central core network system;
establishing, using a user plane function (UPF) at the compact core system, a connection between the compact AMF and a central AMF at the central core network system over a network slice;
transmitting, by the compact AMF to the central AMF over the network slice using the UPF, an update to a registration data store at the central core network system, wherein the update comprises the data associated with the compact core system;
establishing, by the compact AMF and a compact session management function (SMF) at the compact core system, a session with a user equipment (UE);
obtaining, by the compact AMF, data associated with the UE; and
transmitting, by the compact AMF to the central AMF over the network slice using the UPF, the data associated with the UE based on a rule governing the transmission of the data to the central core network.

9. The method of claim 8, wherein the registration request of the compact core system is added to the registration data store when the compact core is not pre-registered with the central core network system and when the compact core system is not associated with a user account or subscription plan.

10. The method of claim 8, wherein the data comprises data usage statistics related to the session or system data usage statistics related to the usage of the compact core system.

11. The method of claim 8, wherein the network slice may be a dedicated network slice for communications between one or more compact core systems and the central core network system, and wherein the network slice employs at least one of encryption protocols, authentication mechanisms, access controls, or auditing.

12. The method of claim 8, wherein after establishing, using the UPF, the connection between the compact AMF and the central AMF, the method further comprises transmitting, by the compact AMF, the data associated with the compact core system to the central AMF, wherein the data associated with the compact core system comprises at least one of the identifier of the compact core system, the location of the compact core system, the one or more capabilities of the compact core system, or one or more rules governing session establishment and management at the compact core system.

13. The method of claim 8, wherein establishing, by the compact AMF and the compact SMF at the compact core system, a session with the UE comprises:
receiving, by the compact AMF, a session establishment request from the UE to establish the session between the UE and an external system;
configuring, by the compact SMF, a second UPF at the compact core system with forwarding rules to route traffic between the UE and the external system; and
establishing, by the second UPF, a data path for user plane traffic between the UE and the external system.

14. The method of claim 8, wherein establishing, by the compact AMF and the compact SMF at the compact core system, a session with the UE comprises completing a UE registration between the UE and the compact core system.

15. A method, comprising:
determining, by a compact access and mobility management function (AMF) at a compact core system, that a user equipment (UE) has moved out of a coverage area of the compact core system after a session is established with the UE under management of the compact core system;
transmitting, by the compact AMF over a network slice using a first user plane function (UPF) at the compact core system, a handover request to a central AMF at a central core network system;
transmitting, by the central AMF over the network slice using a second UPF, a response to the compact AMF to confirm initiation of a handover from the compact core system to the central core network system;
transmitting, by the compact AMF, a first instruction to a serving cell site to execute the handover by terminating a first connection with the UE; and
transmitting, by the central AMF, a second instruction to a target cell site to execute the handover by initiating a second connection with the UE to continue the session under management of the central core network system.

16. The method of claim 15, further comprising:
completing, by the compact AMF, a registration of the compact core system by adding or confirming data associated with the compact core system at a registration data store in the compact core system and the central core network system;
establishing, using the first UPF at the compact core system, a connection between the compact AMF and the central AMF over the network slice; and
establishing, by the compact AMF and a compact session management function (SMF) at the compact core system, a session with the UE under management of the compact core system.

17. The method of claim 16, wherein the registration is completed in response to a registration request, wherein the registration request comprises the data associated with the compact core system, wherein the data comprises an identifier of the compact core system, a location of the compact core system, and one or more capabilities of the compact core system.

18. The method of claim 16, wherein establishing, by the compact AMF and the compact SMF at the compact core system, a session with the UE comprises:
receiving, by the compact AMF, a session establishment request from the UE to establish the session between the UE and an external system;
configuring, by the compact SMF, a second UPF at the compact core system with forwarding rules to route traffic between the UE and the external system based on one or more policies; and
establishing, by the second UPF, a data path for user plane traffic between the UE and the external system.

19. The method of claim 16, wherein establishing, by the compact AMF and the compact SMF at the compact core system, the session with the UE comprises completing a UE registration between the UE and the compact core system, wherein completing the registration of the compact core system comprises transmitting, by the compact AMF, a registration request to the central core network system, wherein the registration request comprises data associated with the compact core system.

20. The method of claim 19, wherein after establishing, using the first UPF, the connection between the compact AMF and the central AMF, the method further comprises transmitting, by the compact AMF, the data associated with the compact core to the central AMF, wherein the data associated with the compact core comprises at least one of an identifier of the compact core system, a location of the compact core system, one or more capabilities of the compact core system, or one or more rules governing session establishment and management at the compact core system.
